(19) United States
(12) Patent Application Publication
(10) Pub. No.: US 2007/0127467 A1
(43) Pub. Date: Jun. 7, 2007

(54) Segmentation and reassembly receiver operation

(75) Inventor: Seung June Yi, Seoul (KR)

Correspondence Address: L. Howard Chen, Esq.;Kirkpatrick & Lockhart Preston Gates Ellis LLP, Suite 1700, 55 Second Street, San Francisco, CA, 94105, US

(73) Assignee: VIA Telecom Co., Ltd.

(21) Appl. No.: 11/605,769

(22) Filed: Nov. 29, 2006

Related U.S. Application Data
(60) Provisional application No. 60/741,525, filed on Dec. 1, 2005.

(51) Int. Cl. H04L 12/56; H04J 3/24

(52) U.S. Cl. 370/389; 370/473

(57) ABSTRACT

A method for eliminating useless waiting for lost data units in a segmentation and reassembly (SAR) receiver operation is disclosed. The SAR receiver checks for any missing data units upon receiving a transmission of a plurality of data units in a predetermined sequence, storing all received data units following a first missing data in the SAR receiver, starting an abort timer for every missing data unit and delivering the stored data units between a first missing data unit and a second missing data unit if the abort timer for the first missing data unit has expired and the abort timer for the second missing data unit has not expired.

### CROSS REFERENCE

This application claims the benefits of U.S. Patent Application Ser. No. 60/741,525, which was filed on Dec. 1, 2005 and entitled “SAR receiver operation”

### BACKGROUND

The present invention relates generally to communication protocols, and more particularly, to the operation of segmentation and reassembly layer protocol for packet communications.

Information is transmitted through the Internet or a wireless network in packets. The packets are made smaller before transmitting to speed through the network, and specifically because some path may have packet size restrictions. Both sending and receiving devices have stacks of communication protocol layers for processing and transmitting the packets. Segmentation and reassembly (SAR) is a layer protocol for breaking a packet into smaller units before transmission and reassembling them into a proper order at the receiving end of the communication. To achieve low radio link error rate, SAR also provides retransmission and duplicate detection of higher layer octets or packets.

A SAR sender receives octets or packets for transmission from a higher layer, and stores them sequentially in the transmission buffer. For transmission, the SAR sender forms a SAR packet by preparing a SAR packet header and a SAR payload. The SAR packet header includes a SEQ field, which stores a SAR sequence number by which the SAR sender and receiver identify different SAR packets.

The content of SAR payload and SEQ field are different between octet streams and packet streams. If a link serves an octet stream, then a data unit is an octet, and the SAR payload contains a number of the contiguous data units. The SEQ field indicates the sequence number of the first data unit in the SAR payload, and the sequence numbers of the following data units are deduced from the SEQ field and the position of each data unit.

If the link serves a packet stream, then a data unit is contiguous octets belonging to a higher layer packet, and a SAR payload contains a single data unit. A data unit contains either a part of a higher layer packet or an entire higher layer packet depending on the size of the higher layer packet. The SEQ field in the SAR packet header stores the sequence number of the data unit in the SAR payload.

After forming a SAR packet, a SAR sender transmits it to a SAR receiver through a radio interface. The SAR sender also stores the SAR packet in a transmission buffer for the provision of possible retransmission.

If the SEQ field of the received SAR packet consecutively follows the sequence number of the last data unit delivered to a higher layer, the SAR receiver then delivers the received packet to the higher layer, otherwise, the SAR receiver stores the received packet in a reception buffer with a position indicated by the sequence number, and send a Nak (negative acknowledge) message to the SAR sender requesting a retransmission of the missing data unit. A stored data unit is delivered to a higher layer only after all the prior data units are delivered.

In some cases, a missing data unit remains missing after a retransmission, so any further waiting by the SAR receiver becomes useless. Then an abort timer is used. After a predetermined period of time, a missing data unit will be skipped, and the SAR receiver delivers stored subsequent data units to the higher layer, and then goes to the next missing data and waits for its retransmission or its abort timer's expiration. In bad radio conditions, multiple SAR packets could be lost during transmission and retransmission. In this case, their abort timers start at the same time, and end at the same time, but the SAR receiver still wait at every lost data unit, even though the abort timers for all these lost data units have expired during the waiting for the first lost data unit, then the waiting for a subsequent lost data unit is useless and causes delay for subsequent data transmission, which degrades overall transmission throughput.

What is needed is a method for eliminating useless wait state by bypassing any waiting for a permanent lost data.

### SUMMARY

In view of the foregoing, a method for eliminating useless waiting for lost data units in a segmentation and reassembly (SAR) receiver operation is disclosed. The SAR receiver checks for any missing data units upon receiving a transmission of a plurality of data units in a predetermined sequence, storing all received data units following a first missing data unit in the SAR receiver, starting an abort timer for every missing data unit and delivering the stored data units between a first missing data unit and a second missing data unit if the abort timer for the first missing data unit has expired and the abort timer for the second missing data unit has not expired.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows a part of components of a SAR system.

FIG. 2 is a flow chart for illustrating steps taken in a traditional SAR system when a transmission encountering only one missing data unit at a time.

FIG. 3 is a flow chart for illustrating steps taken in a traditional SAR system when a transmission encountering two missing data units at a time.

FIG. 4 is a flow chart for illustrating steps taken in a SAR system dealing with two missing data units at a time according to one embodiment of the present invention.

FIG. 5 is a flow chart depicting an alternative method of dealing with two missing data units at a time according to one embodiment of the present invention.

### DESCRIPTION

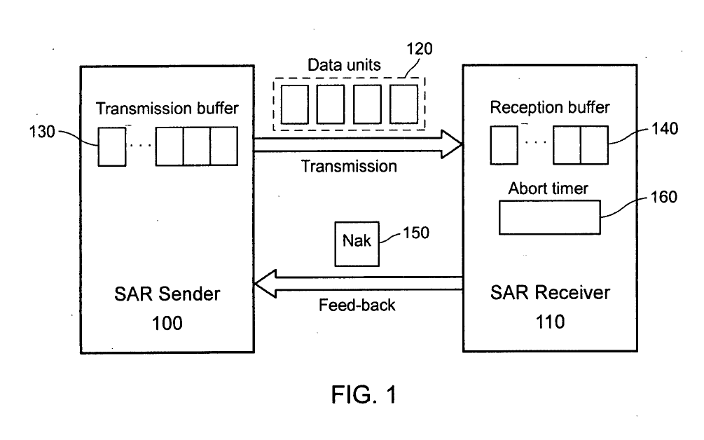

FIG. 1 illustrates a part of segmentation and reassembly (SAR) system with a SAR sender 100 and receiver 110. The SAR sender 100 transmits data units 120 to the SAR receiver 110, and at the same time stores the transmitted data units 120 in a transmission buffer 130 for the provision of possible retransmission. Upon receiving the transmitted data units 120, the SAR receiver 110 delivers consecutively sequenced data units, to an upper layer, and stores those data units following a missing data unit, in a reception buffer 140, and then feeds back a negative acknowledgement 150, or Nak, back to the SAR sender 100. In order to set a time limit for waiting for a missing data unit's retransmission, the SAR receiver 110 provides abort timers 160 and starts one when a missing data unit is detected.

In order not to degrade quality of service (QoS) in voice calls, the abort timer 160 is normally set at less than 400 ms.

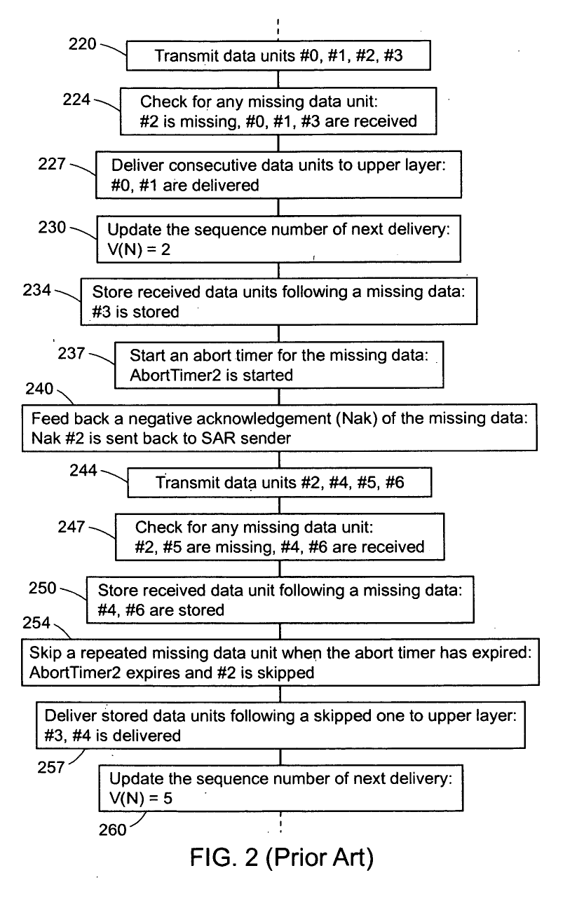

FIG. 2 is a flow chart that gives more details on a traditional SAR sender-receiver operation. Referring to both FIGS. 1 and 2, a SAR sender 100 transmits data units, #0˜#3, to a SAR receiver 110 in step 220. The SAR receiver 110 checks for any missing data units in step 224, and in this case, it finds that data unit #2 is missing. Then the SAR receiver 110 delivers consecutive data units #0 and #1 to an upper layer in step 227, and updates the sequence number of next delivery, V(N)=2. Data unit #3 is received, but follows a missing data unit #2, so it is stored in a reception buffer 140 in the SAR receiver 110 in step 234. Meanwhile an abort timer 160 for the missing data unit #2, AbortTimer2 is started in step 237, and a negative acknowledgement 150, or Nak, of the missing data unit #2 is also fed back to the SAR sender 100 in step 240. Then the SAR receiver is in a wait state. In response to the Nak 150, the SAR sender 100 makes another transmission of data units #2 along with additional data units, #4˜#6 in step 244. Then the SAR receiver 110 checks again for any missing data unit in step 247, and finds that data unit #2 is missing again and so is a newly transmitted data unit #5. Received data unit #4 and #6 are stored during step 250. When the AbortTimer2 expires, the SAR receiver 110 skips the repeated missing data unit #2 in step 254, and delivers the stored data units #3 and #4 to the upper layer in step 257, and then updates V(N)=5 in step 260.

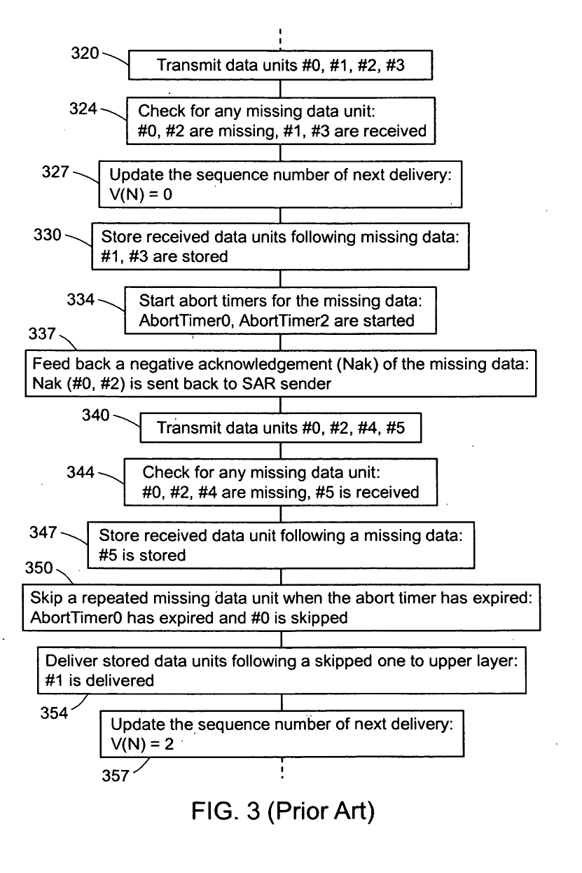

The traditional operation works perfectly fine when there is only one missing data unit in a single transmission. But if there is more than one data unit missing, the useless waiting by the SAR receiver 110 will occur as shown in FIG. 3.

FIG. 3 is another flow chart illustrating the same traditional SAR sender-receiver operation, but has two data units missing in a transmission. Referring to both FIGS. 1 and 3, after a first transmission in step 320, the SAR receiver 110 checks out that both #0 and #2 data units are missing in step 324. The sequence number of next delivery is set to the first missing data unit, V(N)=0, in step 327. Two abort timers 160, AbortTimer0 and AbortTimer2, are started simultaneously in step 334. After a retransmission in step 340, data units #0 and #2 are still missing in step 340 and 344. Traditional SAR operation skips one missing data unit at a time, so upon the expiration of AbortTimer0, data unit #0 is skipped in step 350, but not the data unit #2, even though AbortTimer2 has also expired at the same time as AbortTimer0, since they have been started at the same time. The sequence number of next delivery is updated to V(N)=2 in step 357, which means the SAR receiver 110 waits for data unit #2. This wait state is useless as data unit #2 is twice missing in the transmissions in steps 320 and 340, and should be skipped right after its abort timer expires.

To eliminate the useless wait state, a first embodiment of the present invention employs a method to skip any number of repeated missing data units as long as their abort timers expire.

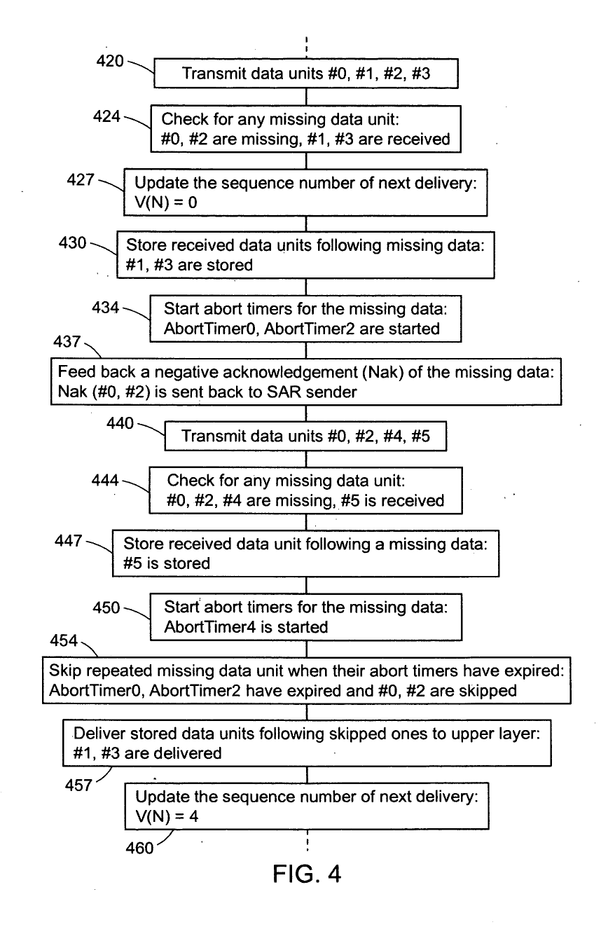

FIG. 4 is a flow chart for illustrating steps taken in a SAR system with a sender 100 and a receiver 110 dealing with two missing data units at a time according to aforementioned embodiment of the present invention. Referring to both FIGS. 1 and 4, two data units, #0 and #2 are missing in first transmission in step 420, which are checked out by the SAR receiver 110 at step 424. In step 427, the SAR receiver update a sequence number, V(N), of next delivery, which is ‘0’ in this case, as the first missing data unit is #0. The SAR receiver 110 stores all received data units, #1 and #3 in its buffer in step 430. At the same time, the SAR receiver 110 starts two abort timers 160 for the missing data units, AbortTimer0 for data unit #0 and AbortTimer2 for data unit #2. Then a negative acknowledgement (Nak) signal is sent back to the SAR sender 100 in step 437. The SAR sender 100 re-transmits the previously missing data units #0 and #2 in a next transmission in step 440. But data units #0 and #2 are missing again which is checked out in step 444. As AbortTimer0 and AbortTimer2 are started at the same time in step 434, they also expire at the same time, and then both data unit #0 and #2 are skipped together in step 457 according to the present invention, instead of skipping one missing data unit at a time. The sequence number of next delivery is set to V(N)=4 directly in step 460.

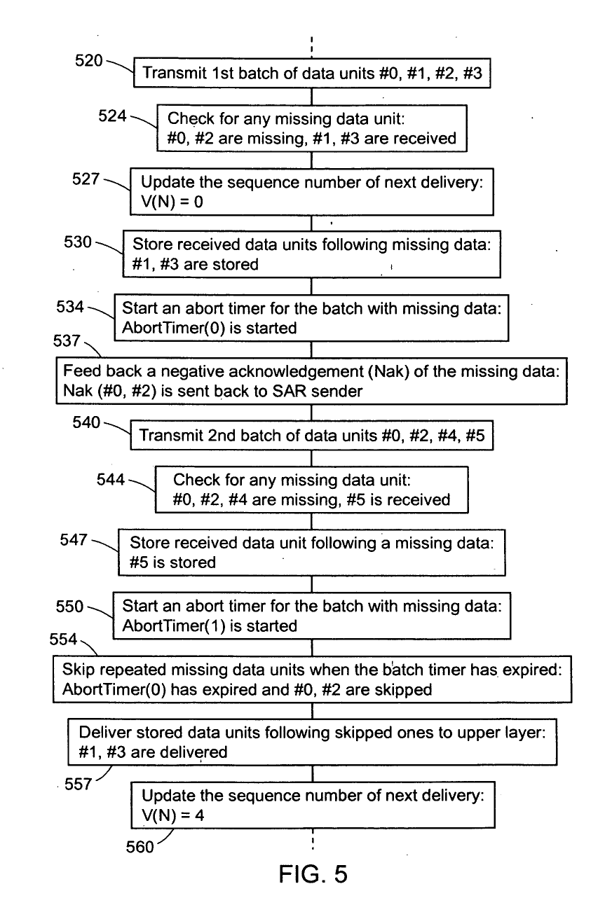

FIG. 5 shows a flow chart of an alternative embodiment of the present invention. Referring to both FIGS. 1 and 5, data units #0 and #2 are missing in a first batch of transmission in steps 520 and 524. A sequence number of next delivery is set to V(N)=0 as a first missing data unit is #0. All received data units, #1 and #3, are stored in a SAR receiver 110 in step 530. In step 534, only one abort timer 160, AbortTimer(0), is started for both missing data units #0 and #2, or any number of missing data units in a same batch of transmission according to the alternative embodiment of the present invention. Feedback of negative acknowledgement (Nak) of the missing data units #0 and #2 is sent back to a SAR sender 100. The data units #0 and #2 are re-transmitted in a second batch of transmission as shown in step 540. Again, the data units #0 and #2 are missing in step 544 along with a newly missed data unit #4. A received data unit #5 is stored in step 547. Since the second batch of transmission has the newly missing data unit #4, another abort timer 160, AbortTimer(1) is started for the second batch of transmission in step 550. In step 554, both repeated missing data units #0 and #2 are skipped once AbortTimer(0) expires. Then the stored data units #1 and #3 following the skipped missing data units #0 and #2 are delivered to an upper layer of the SAR receiver 110. Now the earliest active missing data is #4, so the sequence number of next delivery is set at V(N)=4.

The method of using just one abort timer for a batch of transmission as long as it has at least one missing data unit and regardless how many are missing in the same batch, achieves the same result as the embodiment illustrated in FIG. 4.

Although illustrative embodiments of this invention have been shown and described, other modifications, changes, and substitutions are intended. Accordingly, it is appropriate that the appended claims be construed broadly and in a manner consistent with the scope of the disclosure, as set forth in the following claims.

What is claimed is:

1. A method for eliminating useless wait state in a segmentation and reassembly (SAR) receiver with one or more abort timers, the method comprising:
checking for any missing data units upon receiving a transmission of a plurality of data units in a predetermined sequence;
storing all received data units following a first missing data in the SAR receiver;
starting an abort timer for every missing data unit; and
delivering the stored data units between a first missing data unit and a second missing data unit when the abort timer for the first missing data unit has expired and the abort timer for the second missing data unit has not expired.

2. The method of claim 1 further comprising delivering all received data units prior to the first missing data in the predetermined sequence.

3. The method of claim 1 further comprising feeding back a negative acknowledgement to request a retransmission for every missing data units.

4. The method of claim 3 further comprising delivering the stored data units between a first missing data unit and a second missing data unit along with one or more successfully retransmitted data units if the first missing data unit has successfully retransmitted and the second missing data unit remains missing.

5. The method of claim 1, wherein the duration of the abort timer is set at less than 400 ms.

6. A method for eliminating useless wait state in a segmentation and reassembly (SAR) receiver with one or more abort timers, the method comprising:
checking for any missing data units upon receiving a transmission of a plurality of data units transmitted in a predetermined sequence;
storing all received data units following a first missing data unit in the SAR receiver;
starting an abort timer if there is one or more missing data units in the transmission; and
delivering the stored data units received during the transmission upon an expiration of the abort timer.

7. The method of claim 6 further comprising delivering all received data units prior to the first missing data in the predetermined sequence.

8. The method of claim 6 further comprising feeding back a negative acknowledgement to request a retransmission for every missing data units.

9. The method of claim 8 further comprising delivering the stored data units between a first missing data unit and a second missing data unit along with one or more successfully retransmitted data units if the first missing data unit has successfully retransmitted and the second missing data unit remains missing.

10. The method of claim 6, wherein the duration of the abort timer is set at less than 400 ms.

11. A method for eliminating useless wait state in a segmentation and reassembly (SAR) receiver with one or more abort timers, the method comprising:
checking for any missing data units upon receiving a transmission of a plurality of data units transmitted in a predetermined sequence;
storing all received data units following a first missing data in the SAR receiver;
starting an abort timer if there is one or more missing data units in the transmission;
feeding back a negative acknowledgement to request a retransmission for every missing data units;
delivering all received data units prior to the first missing data in the predetermined sequence; and
delivering the stored data units received during the transmission upon an expiration of the abort timer.

12. The method of claim 11 further comprising delivering the stored data units between a first missing data unit and a second missing data unit along with one or more successfully retransmitted data units if the first missing data unit has successfully retransmitted and the second missing data unit remains missing.

13. The method of claim 11, wherein the duration of the abort timer is set at less than 400 ms.
